(19) United States
(12) Patent Application Publication
(10) Pub. No.: US 2006/0197846 A1
(43) Pub. Date: Sep. 7, 2006

(54) Image-taking apparatus

(75) Inventor: Syuji Nose, Asaka (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/362,018

(22) Filed: Feb. 27, 2006

(30) Foreign Application Priority Data
Mar. 3, 2005 (JP) 2005-059420

(51) Int. Cl. H04N 9/73

(52) U.S. Cl. 348/226.1

(57) ABSTRACT

An image-taking apparatus performs a correct dimming process while eliminating an influence of flickers in the case of image taking by use of flash light under a flicker light source that exhibits intensity variation of illumination light at a commercial power source frequency of 50 Hz or 60 Hz. A time period of 50 milliseconds is defined as a process cycle as zero points coincide with each other between those of the two frequencies. An amount of light received from an object field is obtained in a first 50-millisecond interval after a full-press action, and an amount of preliminary light emission is obtained in a second 50-millisecond interval. An appropriate amount of light for main light emission is obtained in a third 50-millisecond interval. In this way, main light emission is performed at an accurate amount of light emission.

### BACKGROUND OF THE INVENTION

1. Field of the Invention

The present invention relates to an image-taking apparatus configured to perform image taking by use of flash firing depending on an image-taking operation.

2. Description of the Related Art

There are many image-taking apparatuses including a flash firing device for performing flash firing depending on an image-taking operation. Some of those image-taking apparatuses include a dimming function to control an amount of light emission of flash light into an appropriate value. Such a dimming function is roughly categorized into a type configured to perform preliminary light emission in preparation to main light emission and thereby to calculate an amount of light emission at the time of the main light emission (hereinafter referred to as a “preliminary light emission type”), and a type configured to receive reflection of flash light reflected by an object field using a dimmer sensor and to stop emission of the flash light when an amount of the received light reaches a predetermined value (hereinafter referred to as a “dimmer sensor type”).

Incidentally, when taking an image indoors, it may be favorable to perform image taking by using flash light depending on brightness of room lamps.

Here, in the case of image taking with an image-taking apparatus including the dimming function of the preliminary light emission type, overexposure, underexposure, or the like may occur because the amount of light emission at the time of main light emission is not accurately calculated due to flickers caused by room lamps functioning as illumination.

This is caused by the following reason. Specifically, most of room lamps receive electric supply from commercial power sources, and the commercial power sources have a frequency of 50 Hz in the eastern half of Japan while the commercial power sources have a frequency of 60 Hz in the western half of Japan. As a consequence, light intensity of the illumination varies synchronously with the frequencies of the commercial power sources of 50 Hz or 60 Hz, for example, and room lamps therefore start flickering (such room lamps will be hereinafter referred to as a “flicker light source”).

Japanese Unexamined Patent Application Publication No. 2000-250103 discloses a technique of suppressing unevenness of colors in an image per field by changing a light emission parameter of flash light for every field signals equivalent to two fields that constitute an image in one frame. However, this technique is designed for resolving a difference in a component light characteristic in a xenon lamp associated with a voltage variation of a main capacitor. In other words, this technique is not designed for resolving overexposure or underexposure caused in the course of image taking under the flicker light source.

### SUMMARY OF THE INVENTION

The present invention has been made in view of the above circumstances and provides an image-taking apparatus which optimizes exposure in the case of image taking by use of flash light under a flicker light source.

An image-taking apparatus of the present invention is an image-taking apparatus which performs image taking by use of flash firing depending on an image-taking operation. Here, the image-taking apparatus includes a flash firing section which performs preliminary light emission at a given amount of light prior to image taking and performs main light emission at a controlled amount of light at the time of image taking. The image-taking apparatus also includes a light amount calculating section, which measures an amount of light received from an object field at the time of emitting no flash light and an amount of light received from the object field at the time of the preliminary light emission respectively at a time interval satisfying an identical phase to an intensity variation of illumination light when the object field is exposed to illumination by a flicker light source, and calculates an amount of light to be emitted at the time of the main emission of the flash light based on the amounts of received light. Moreover, the image-taking apparatus includes a light amount controlling section which causes the flash firing section to emit light at the amount of light calculated by the light amount calculating section.

According to the image-taking apparatus of the present invention, the amount of light received from the object field at the time of emitting no flash light and the amount of light received from the object field at the time of the preliminary light emission are respectively measured by the light amount calculating section at the time interval satisfying the identical phase to the intensity variation of illumination light when the object field is exposed to illumination by the flicker light source. Moreover, the amount of light to be emitted at the time of the main emission of the flash light is calculated based on the amounts of light received.

Accordingly, the amount of light received from the object field at the time of emitting no flash light, i.e. the amount of illumination light, and the amount of light received from the object field at the time of preliminary light emission are respectively measured at the time interval satisfying the identical phase to the intensity variation of the illumination light. In this way, it is possible to calculate the amount of the flash light to be emitted at the time of main light emission as if there are no flickers.

In short, it is possible to realize an image-taking apparatus which optimizes even the exposure in the case of image taking by use of the flash light under the flicker light source.

Here, the image-taking apparatus may include a flicker detecting section which detects whether the object field is exposed to illumination by the flicker light source. In this case, the light amount calculating section preferably measures the amount of light received from the object field at the time of emitting no flash light and the amount of light received from the object field at the time of the preliminary light emission respectively at a first time interval satisfying the identical phase to the intensity variation of illumination light when the flicker detecting section detects that the object field is exposed to illumination by a flicker light source, and calculates the amount of light to be emitted at the time of the main emission of the flash light based on the amounts of received light. Moreover, the light amount calculating section preferably measures the amount of light received from the object field at the time of emitting no flash light and the amount of light received from the object field at the time of the preliminary light emission respectively at a second time interval shorter than the first time interval when the flicker detecting section detects that the object field is not exposed to illumination by the flicker light source, and calculates the amount of light to be emitted at the time of the main emission of the flash light based on the amounts of received light.

As a result of providing the flicker detecting section, when the flicker detecting section detects presence of a flicker light source, the light amount calculating section calculates the amount of light to be emitted at the time of the main light emission accurately by measuring twice (once at the time of no light emission and once while performing the preliminary light emission) at the first time interval satisfying the identical phase to the intensity variation of the illumination light. Meanwhile, when the flicker detecting section does not detect that the object field is not exposed to the illumination by a flicker light source, the light amount calculating section calculates the amount of light to be emitted at the time of the main light emission by measuring twice (once at the time of no light emission and once while performing the preliminary light emission) at the second time interval which is shorter than the first time interval.

Accordingly, when there is a flicker light source, it is possible to calculate the accurate amount of emitted light so as to cancel an influence by the flicker light source. On the contrary, when there is no flicker light source, it is possible to perform a high-speed process.

Meanwhile, the image-taking apparatus may further include a release button of a two-stage type allowing a full-press action and a half-press action. Here, the light amount calculating section is operated by the full-press action. Moreover, when the release button is fully pressed down at once, the light amount calculating section preferably measures the amount of light received from the object field at the time of emitting no flash light and the amount of light received from the object field at the time of the preliminary light emission respectively at the second time interval, and calculates the amount of light to be emitted at the time of the main emission of the flash light based on the amounts of received light.

When the release button is pressed down at once, the light amount calculating section judges that the appropriate timing for taking image is more important and calculates the amount of light at the main light emission of the flash light at the second time interval which is shorter than the first time interval.

Accordingly, exposure adjustment is performed in a short time period when the release button is fully pressed down. In this way, timing for pressing the release button has priority at a right moment for image taking, whereby a user can take an on-target image.

Here, the image-taking apparatus may include a mode selecting section which selects a desired image-taking mode out of multiple image-taking modes defining mutually different image-taking conditions. In this case, the light amount calculating section preferably measures the amount of light received from the object field at the time of emitting no flash light and the amount of light received from the object field at the time of the preliminary light emission respectively at the second time interval depending on the image-taking mode selected by the mode selecting section, and calculates the amount of light to be emitted at the time of the main emission of the flash light based on the amounts of received light.

When the mode selecting section selects an image-taking mode such as a sports mode, an image is often taken at a high shutter speed because the object field is moving. Therefore, when the sports mode is selected from the multiple image-taking modes, for example, it is convenient if the image-taking apparatus is also configured to perform dimming process at the second time interval shorter than the first time interval as similar to the case where the release button is fully pressed down at once.

Accordingly, a high shutter speed has priority and the dimming process is executed in a short time period. In this way, the user can capture realistic movement of the object field.

In addition, the flicker detecting section preferably detects whether the object field is exposed to illumination by a flicker light source, and detects a cycle of flickers when the object field is exposed to the flicker light source. Here, the light amount calculating section preferably measures the amount of light received from the object field at the time of emitting no flash light and the amount of light received from the object field at the time of the preliminary light emission respectively at the first time interval synchronized with the cycle detected by the flicker detecting section, and calculates the amount of light to be emitted at the time of the main emission of the flash light based on the amounts of received light.

Accordingly, the flicker detecting section detects that the cycle of the intensity variation of the flicker light source is synchronized with a frequency of 50 Hz in the eastern half of Japan, and the flicker detecting section detects that the cycle of the intensity variation of the flicker light source is synchronized with a frequency of 60 Hz in the western half of Japan.

As a result, it is possible to define the first time interval synchronously with any of these cycles. In this way, it is possible to perform the process at a higher speed.

According to the present invention, it is possible to realize an image-taking apparatus which optimizes exposure even in the case of image taking by use of flash light under a flicker light source.

### BRIEF DESCRIPTION OF THE DRAWINGS

FIG. 1 is a perspective view of a front face of a digital camera representing a first embodiment of the present invention, which is viewed from obliquely above.

FIG. 2 is a perspective view of a back face of the digital camera representing the first embodiment of the present invention, which is viewed from obliquely above.

FIG. 3 is a block diagram showing a circuit configuration of the digital camera shown in FIGS. 1 and 2.

FIG. 4 is a diagram showing degrees of time intervals satisfying an identical phase to intensity variation of illumination light emitted by a flicker light source.

FIG. 5 is a flowchart showing an image-taking process to be executed by a central processing unit.

FIG. 6 is flowchart performed by a digital camera according to a second embodiment of the present invention.

FIG. 7 is a flowchart showing procedures of a process for judging whether intensity variation of a flicker light source is attributed to a commercial power source at a frequency of 50 Hz or to a commercial power source at a frequency of 60 Hz.

FIG. 8 is a diagram for explaining the process shown in the flowchart of FIG. 7.

### DETAILED DESCRIPTION OF THE INVENTION

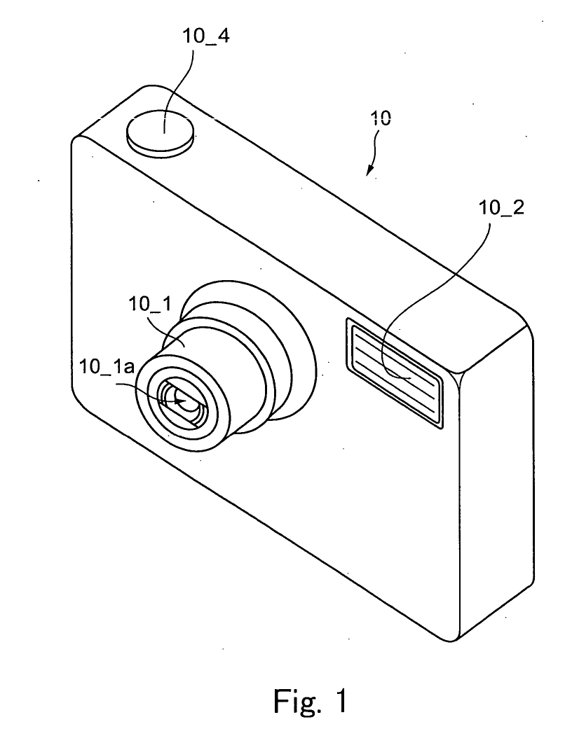

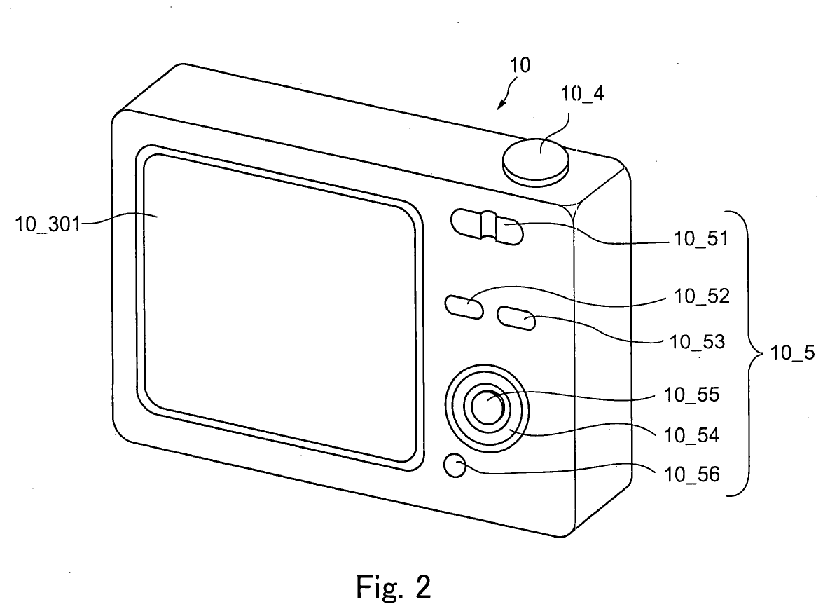

FIG. 1 and FIG. 2 are perspective views of a digital camera representing a first embodiment of the present invention, which illustrate front and back faces viewed from obliquely above, respectively.

A lens barrel 10_1 is disposed on the front face of a digital camera 10 shown in FIG. 1 in a stretched state so as to protrude from a body. This lens barrel 10_1 has the stretched mode as shown in FIG. 1, and a folded mode in which the lens barrel 10_1 is housed inside the body by reducing a barrel length as compared to the barrel length in the stretched mode.

Meanwhile, an image-taking lens 10_1a formed of a focal length variable zoom lens is disposed inside this lens barrel 10_1. Moreover, a flash firing window 10_2 for emitting flash light at the time of image taking is disposed on the front face of this digital camera 10. In addition, a shutter release button 10_4 for giving an image-taking instruction to the camera is arranged on an upper face of the body of the digital camera 10.

On the other hand, an operation key group 10_5 including a T/W (telephoto/wide-angle) switch lever 10_51, an image-taking/playback switch button 10_52, a function button 10_53, a four-way key 10_54, an OK key 10_55 and a DISP/BACK (display/back) key 10_56, and a liquid crystal display (LCD) panel 10_301 for image display are arranged on the back face of the digital camera 10 as shown in FIG. 2.

Here, the T/W switch lever 10_51 in the operation key group 10_5 is a lever for switching a focal length of the image-taking lens 10_1a. Meanwhile, the image-taking/playback switch button 10_52 is a button for switching a mode of this digital camera 10 between an image-taking mode and a playback mode every time when the button is pressed down.

Moreover, a menu is displayed on the LCD panel 10_301 by pressing the function button 10_53. Thereafter, the menu is switched by use of right and left buttons of the four-way key 10_54 and a certain item in the menu is selected by use of upper and lower buttons of the four-way key 10_54. The selected item is set up by pressing the OK key 10_55. This operation enables various settings of items in the image-taking mode including a setting for a sports mode, a setting for ISO (the International Standardization Organization) sensitivity, a setting for use of flash firing, and the like, and also enables various settings of items in the playback mode.

Furthermore, the DISP/BACK key 10_56 is a key which is pressed down in the playback mode, for example, for sequentially switching a display mode of images (such as displaying one image, displaying an array of thumbnail images, and the like) to be displayed on the LCD panel 10_301 or for restoring a previous display image.

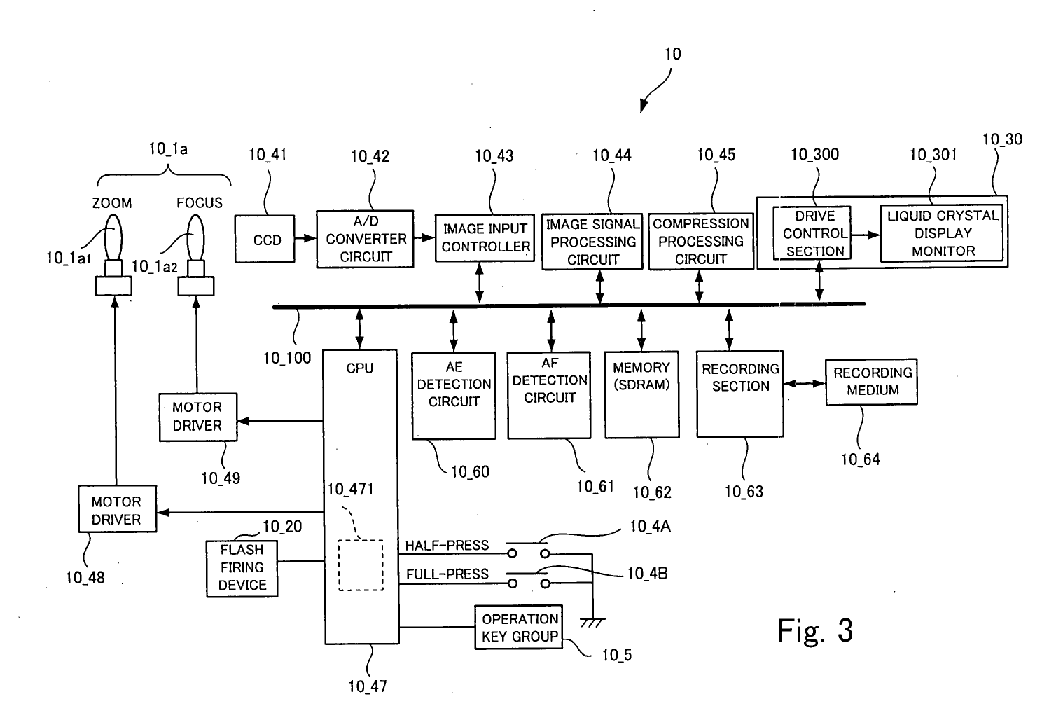

FIG. 3 is a block diagram showing a circuit configuration of the digital camera 10 shown in FIG. 1 and FIG. 2.

Operations of this digital camera 10 are comprehensively controlled by a central processing unit (CPU) 10_47. In this embodiment, the CPU 10_47 incorporates a program memory 10_471, and processes concerning the operations of this digital camera 10 are executed in accordance with a program stored in this program memory. This program includes descriptions for a dimming process as well.

Now, the circuit configuration of this digital camera 10 will be briefly described along a flow of an image signal.

FIG. 3 illustrates an image-taking lens 10_1a necessary for operating circuits located at subsequent stage to an image pickup device (which applies a CCD (charge-coupled device) solid-state image pickup device in this embodiment and will be hereinafter referred to as a CCD accordingly) 10_41. To explain the formation of the image-taking lens 10_1a, FIG. 3 also illustrates main constituents of the image-taking lens 10_1a, namely, a zoom lens element 10_1a1 and a focus lens element 10_1a2. Object light is focused on the CCD 10_41 located at the subsequent stage by use of the image-taking lens 10_1a including these lens elements. Accordingly, the CCD 10_41 is caused to generate an image signal which represents the object light.

Now, a method of allowing the CCD 10_41 to generate the image signal and a method of transmitting the generated image signal to the circuit located at the subsequent stage will be described below.

First, a flow of an image signal representing a through image (live view) will be described. Here, the through image is supposed to be displayed on the LCD monitor 10_301 when power is turned on and the image-taking/playback switch button 10_52 is set to the image-taking mode.

Upon generation of the image signal for the through image by the CCD 10_41, the CCD 10_41 is caused to generate the image signal representing the through image at a given cycle by supplying an exposure start signal and an exposure end signal from an unillustrated timing generator to the CCD 10_41 repeatedly at the given cycle under control of the CPU 10_47 as will be described later. In response to the exposure end signal from this timing generator (not shown), the exposure to the CCD 10_41 is terminated and the image signal (hereinafter referred to as an RGB signal) representing the through image is outputted from the CCD 10_41 almost at the same time.

In this way, when the RGB signal for the through image is outputted to an analog/digital (A/D) converter circuit 10_42, the analog RGB signal is converted into a digital RGB signal by the A/D converter circuit 10_42. Then, the digital RGB signal is guided to a bus line 10_100 through an image input controller 10_43 located at the subsequent stage.

The digital RGB signal for the through image guided to the bus line 10_100 by this image input controller 10_43 is supplied to an image signal processing circuit 10_44, and the digital RGB signal is converted into a digital YC signal by this image signal processing circuit 10_44. The YC signal converted by the image signal processing circuit 10_44 is supplied to a drive control section 10_300 of a display section 10_30, and an image based on the YC signal is displayed on the liquid crystal display monitor 10_301 of the display section 10_30. Since the YC signals are generated at a given cycle by the CCD 10_41, the images based on the YC signals are switched and displayed on the liquid crystal display monitor 10_301 at the given cycle. In this way, the object field in the orientation of the image-taking lens 10_1a is displayed on the liquid crystal display monitor 10_301 directly as the through image.

That is to say, it is possible to perform image taking by pressing the shutter release button 10_4 at appropriate timing while watching the liquid crystal display monitor 10_301 instead of looking through an optical viewfinder.

Here, when the shutter release button 10_4 is half-pressed in order to take an image at the appropriate timing while watching the through image, a switch (hereinafter referred to as a first contact) 10_4A is connected and the half-press action is detected by the CPU 10_47. When the shutter release button 10_4 is fully pressed down, another switch (hereinafter referred to as a second contact) 10_4B is also connected and the full-press action is detected by the CPU 10_47.

Upon detection of the half-press action, the CPU 10_47 causes an auto exposure (AE) detection circuit 10_60 and an auto focus (AF) detection circuit 10_61 to execute predetermined processes respectively. Upon detection of the full-press action, the CPU 10_47 causes the timing generator (not shown) to output the exposure start signal and the exposure end signal to the CCD 10_41 according to a shutter speed.

The AE detection circuit 10_60 is configured to detect brightness of object field necessary for exposure setting, for example. In accordance with a result of detection by this AE detection circuit 10_60, the CPU 10_47 adjusts an unillustrated aperture diameter or causes a flash firing device 10_20 to emit flash light at the time of the full-press action.

Meanwhile, the AF detection circuit 10_61 is configured to execute processes to detect object contrast in terms of multiple positions on the way of moving the focus lens element 10_1a2 from the nearest point to the farthest point by an instruction to a motor driver 10_49 under control of the CPU 10_47, and thereby to define a peak of the object contrast detected in the multiple positions as a focused focal point.

In this way, the image signal representing the image formed on the CCD 10_41 at the time of the full-press action is outputted by the CCD 10_41, and then the RGB signal converted into the digital signal by the A/D converter circuit 10_42 is guided to the bus line 10_100 by the image input controller 10_43.

The RGB signal guided to the bus line 10_100 is once stored in a memory (a synchronous dynamic random access memory, or a SDRAM) 10_62 as a whole. Thereafter, the RGB signal is read out of the memory 10_62 and is supplied to the image signal processing circuit 10_44. The RGB signal is converted into the YC signal by this image signal processing circuit 10_44, and the converted YC signal is then supplied to a compression processing circuit 10_45 and is subjected to JPEG (Joint Photographic Experts Group) compression by the compression processing circuit 10_45. Further, the JPEG-compressed YC signal is supplied to a recording section 10_63, and header information such as compression information is formed into an image file (an exchangeable image format file, or an Exif file) together with image data by the recording section 10_63, and the image file is recorded on a recording medium 10_64.

The digital camera 10 of this embodiment having the above-described configuration includes the dimming function of the preliminary light emission type. Specifically, when the CPU 10_47 determines that it is necessary to perform flash firing based on the result of detection by the AE detection circuit 10_60, the CPU 10_47 causes the flash firing device 10_20 to perform preliminary light emission and main light emission upon the full-press action of the shutter release button 10_4.

In this embodiment, in order to solve the problem of the related art, the CPU 10_47 firstly causes the AE detection circuit 10_60 to detect the brightness of field, or an amount of illumination light from a light source, at a point immediately after the full-press action instead of causing the flash firing device 10_20 to perform preliminary light emission suddenly. Then, the CPU 10_47 instructs the preliminary light emission after a lapse of a first time interval so as to cause the AE detection circuit 10_60 to detect a total amount of light by summing up the amount of illumination light and an amount of preliminarily emitted light again, and then determines an amount of light at the time of main light emission by obtaining a difference between these two values of the amounts of light. Here, assuming that room lamps are the flicker light source, detection of the amount of illumination light and detection of the preliminarily emitted light is sequentially performed while defining 50 ms as the first time interval of the present invention in order to deal with the flicker light source irrespective of whether the flicker light source is operated at a frequency of 50 Hz or 60 Hz, because both of the frequencies have a cycle of 50 ms in common. In this way, even in a situation under the flicker light source, it is possible to calculate the proper amount of main light emission accurately without an influence of the flicker light source and to perform the main light emission at the accurately calculated amount of light. Accordingly, it is possible to achieve correct exposure on the entire screen.

Now, a description will be made on the reason why the digital camera 10 of the present invention is able to perform the dimming process accurately without being affected by the flicker light source.

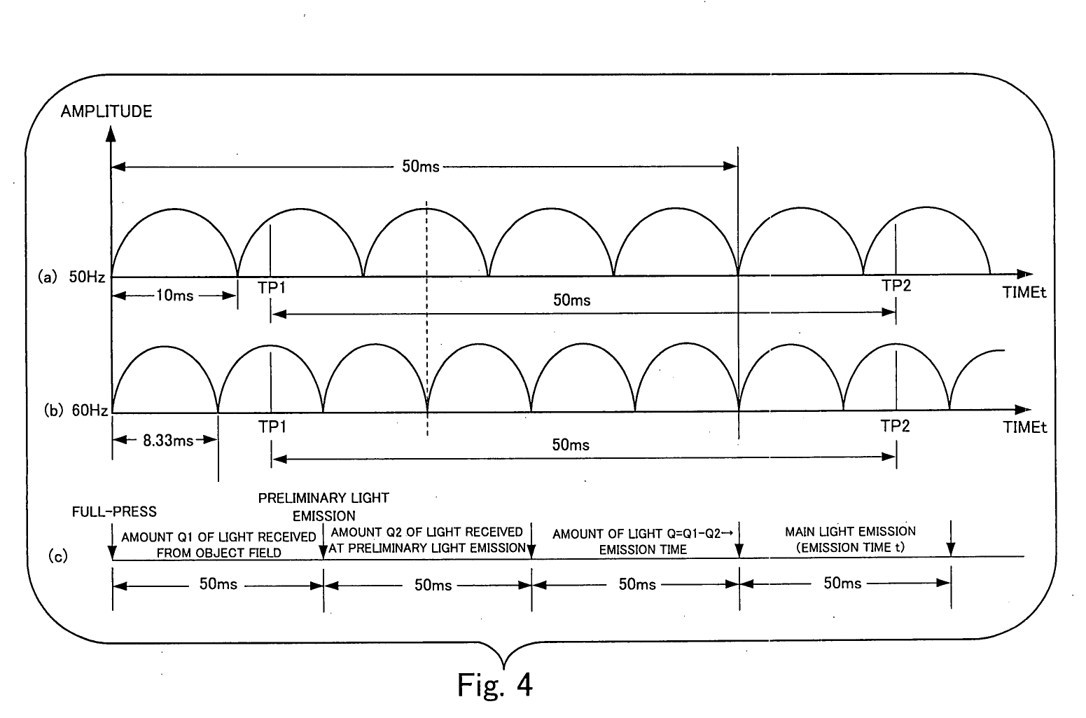

FIG. 4 is a diagram showing degrees of time intervals satisfying an identical phase to intensity variation of illumination light emitted by a flicker light source.

Part (a) of FIG. 4 shows intensity variation of illumination light to which electric power is supplied from a power source having a commercial power source frequency of 50 Hz. Meanwhile, part (b) of FIG. 4 shows intensity variation of illumination light to which electric power is supplied from a power source having a commercial power source frequency of 60 Hz.

Lateral axes in parts (a) and (b) of FIG. 4 indicate time and longitudinal axes thereof indicate amplitude. An assumption is herein made that the illumination light exhibits the intensity variation attributable to pulsation when illumination is achieved as a result of rectifying a power voltage having the commercial power source frequency and applying the power voltage between electrodes of the flicker light source, and a rectified waveform corresponding to the power voltage is illustrated in the drawing. As shown in part (a) of FIG. 4, the cycle is equal to 1/50 s at the frequency of 50 Hz. Accordingly, half waves are observed in every 10 ms as a result of rectification. Meanwhile, the cycle is equal to 1/60 s at the frequency of 60 Hz. Accordingly, half waves are observed in every 8.33 ms as a result of rectification.

A zero point of the amplitude value at the frequency of 50 Hz shown in part (a) of FIG. 4 and a zero point of the amplitude value at the frequency of 60 Hz shown in part (b) of FIG. 4 coincide with each other at every 50 ms. Therefore, by measuring the amount of illumination light at the time of emitting no flash light (at a time point indicated with TP1 in the drawing, for example) and measuring the amount of preliminarily emitted light (at a time point indicated with TP2 in the drawing, for example) at every 50 ms, it is possible to satisfy the identical phase in terms of the intensity variation irrespective of whether the frequency is equal to 50 Hz or 60 Hz. In this way, it is possible to cancel the influence of the flickers virtually.

Accordingly, detection of an amount of light received from the object field and detection of an amount of received light at the time of the preliminary light emission is performed every 50 ms as shown in part (c) of FIG. 4.

Now, the dimming process will be described in detail with reference to part (c) of FIG. 4 and FIG. 3.

In consideration of a possibility that framing may be changed during the half-press action, the digital camera 10 of this embodiment is configured to initiate the dimming process from the moment of full-press action.

First, when the shutter release button 10_4 is fully pressed down, the CPU 10_47 causes the flash firing device 10_20 not to perform light emission in the first 50 ms and allows the CCD 10_41 to receive the amount of light received from the object field. Further, the CPU 10_47 causes the CCD 10_41 to output the image data representing the amount of the received light to the AE detection circuit 10_60 and allows the AE detection circuit 10_60 to detect the amount of illumination light in the object field. During the first process time of 50 ms, the CPU 10_47 receives the detection result of the amount of illumination light generated by the flicker light source.

Next, the CPU 10_47 causes the flash firing device 10_20 to perform preliminary light emission and allows the CCD 10_41 to receive the total amount of light representing the sum of the amount of illumination light generated by the flicker light source and the amount of preliminarily emitted light. Further, the CPU 10_47 causes the CCD 10_41 to output the image data representing the amount of received light to the AE detection circuit 10_60 and allows the AE detection circuit 10_60 to detect the total amount of light. During the second cycle of 50 ms, the CPU 10_47 receives the total amount of light. Then, during the subsequent third cycle of 50 ms, the CPU 10_47 calculates the amount of preliminarily emitted light accurately by subtracting the amount of illumination light received during the second cycle of 50 ms from the total amount of light. In the last cycle of 50 ms, the CPU 10_47 causes the flash firing device 10_20 to perform main light emission for a time period required for achieving the amount of light thus calculated.

In this way, by performing the process at the cycle of 50 ms, it is possible to eliminate the adverse effect of the intensity variation of the illumination light generated by the flicker light source irrespective of whether the light source is operated by the commercial power source having the frequency of 50 Hz or 60 Hz, and thereby to execute the accurate dimming process.

Here, operations of the CPU 10_47 assigned to control the entire image-taking process of this digital camera 10 including the dimming process will be described.

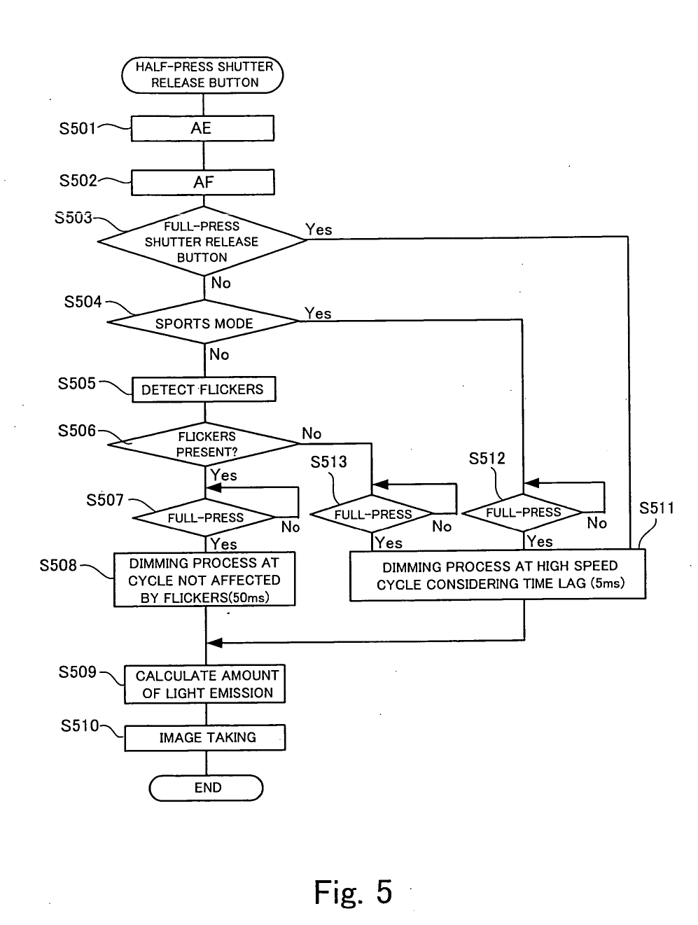

FIG. 5 is a flowchart showing the image-taking process to be executed by the CPU 10_47.

The flow of this process is initiated at the half-press action of the shutter release button 10_4.

The AE detection circuit 10_60 executes an AE process in step S501. When the AE detection circuit 10_60 completes the AE process, the AF detection circuit 10_61 executes an AF process in step S502. Thereafter, the process goes to step S503 and a judgment is made as to whether or not the shutter release button 10_4 is pressed down at once. When the judgment is made that the shutter release button 10_4 is pressed down at once because both of the two contacts 10_4A and 10_4B are connected instantly, the process goes to a Yes side. In step S511, the dimming process is executed at a high-speed cycle by appropriately instructing the timing generator, the AE detection circuit, and the flash firing device in consideration of a time lag. Here, a time period of 5 ms which is close to the maximum readout rate of the CCD 10_41 is defined as a second time interval of the present invention. Accordingly, the AE detection circuit 10_60 detects the amount of illumination light without light emission and causes the flash firing device 10_20 to perform preliminary light emission 5 ms thereafter to conform to the second time interval. In this way, the AE detection circuit 10_60 detects the total amount of light representing the sum of the amount of preliminarily emitted light and the amount of illumination light.

The process goes to the next step S509 to calculate the appropriate amount of light of main light emission. Then, in step S510, the flash firing device 10_20 performs main light emission at the time of image taking by using the amount of light calculated in step S509. Thereafter, the process in this flow is terminated.

On the contrary, when the judgment is made that the shutter release button 10_4 is not pressed down at once in step S503, the process goes to a No side and a judgment is made in step S504 as to whether or not the sports mode is selected. When the judgment is made in step S504 that the sports mode is selected, the process goes to a Yes side and the digital camera 10 stands by for the full-press action in step S512. When the full-press action is detected in step S512, the process goes to step S511 to execute the processes as described in steps S509 and S510. Thereafter, the process in this flow is terminated.

Meanwhile, when the judgment is made in step S504 that the sports mode is not selected, the process goes to a No side and detection of flickers is started in step S505. Presence of flickers is judged in the next step S506. When the judgment is made in step S506 that there are no flickers, the process goes to a No side and the digital camera 10 stands by for the full-press action in step S513. When the full-press action is detected in step S513, the process goes to step S511 to execute the processes as described in steps S509 and S510. Thereafter, the process in this flow is terminated.

Moreover, when the judgment is made in step S506 that there are flickers, the process goes to a Yes side and the digital camera 10 stands by for the full-press action in step S507. When the full-press action is detected in step S507, the dimming process is executed by use of the cycle not affected by the flickers (the 50-ms cycle as shown in FIG. 4). Then, the processes as described in steps S509 and S510 are executed. Thereafter, the process in this flow is terminated.

In this way, in the case where the illumination is a flicker light source, it is possible to perform the main light emission after calculating the amount of light emission accurately by eliminating the influence of the flicker light source. On the contrary, it is possible to perform the high-speed dimming process when there is no flicker light source.

In other words, it is possible to realize an image-taking apparatus which optimizes exposure even in the case of image taking by use of flash light under a flicker light source. Moreover, when the timing of pressing the shutter release button seems more important, such as the case of pressing the shutter release button at once or the case of selecting the sports mode as a mode for taking image, it is also possible to achieve an image-taking apparatus which allows high shutter-speed image taking by performing a high-speed dimming process while giving priority to the timing to press the shutter release button.

It should be noted that although the detection of flickers in step S505 of FIG. 5 is performed after the judgments in steps S503 and S504, step S505 itself is not a time-consuming step. Accordingly, it is possible to place step S505 between steps S503 and S504.

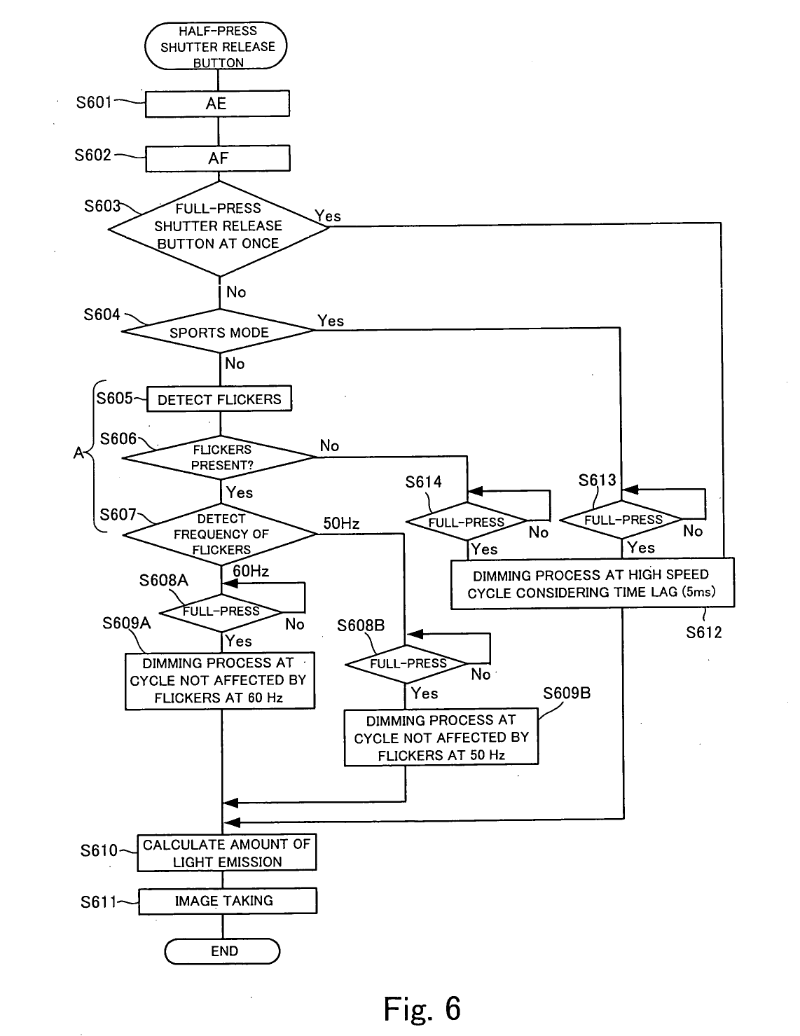

FIG. 6 is a flowchart performed by a digital camera according to a second embodiment of the present invention.

The digital camera according to the second embodiment has an appearance similar to FIGS. 1 and 2 and an internal configuration similar to FIG. 3. However, contents of a program described in an internal memory 10_471 of the CPU 10_47 are different from those shown in FIG. 3. The same components of the second embodiment as those of the first embodiment are denoted with the same reference characters in the following description.

Now, the different procedures will be described with reference to FIG. 6.

In FIG. 5, the process is performed by use of the cycle (50 ms) so as to eliminate the influence of the flicker light source irrespective of whether the intensity variation of the flicker light source is synchronized with the commercial power source having the frequency of 50 Hz or the commercial power source having the frequency of 60 Hz.

On the other hand, in the second embodiment shown in FIG. 6, a detection process is performed in step S607 as to whether the intensity variation of the flicker light source is synchronized with the commercial power source having the frequency of 50 Hz or the commercial power source having the frequency of 60 Hz.

By detecting the commercial power source frequency, it is possible to execute processes at a shorter cycle than the relevant processes described in FIG. 5. For example, some processes need to be executed at the cycle of 50 ms in the forgoing embodiment. On the contrary, in this embodiment, it is possible to perform the relevant processes at a shorter cycle of 8.33 ms or 10 ms as shown in step S609A or S609B, for example.

In this context, a flow of the process will be described below.

As similar to FIG. 5, the flow of this process is initiated at the half-press action of the shutter release button 10_4.

The AE detection circuit 10_60 executes an AE process in step S601. When the AE detection circuit 10_60 completes the AE process, the AF detection circuit 10_61 executes an AF process in step S602. Thereafter, the process goes to step S603 and a judgment is made as to whether or not the shutter release button 10_4 is pressed down at once. When the judgment is made that the shutter release button 10_4 is pressed down at once because both of the two contacts 10_4A and 10_4B are connected instantly, the process goes to a Yes side. In step S612, the dimming process is executed at a high-speed cycle by appropriately instructing the timing generator, the AE detection circuit, and the flash firing device in consideration of a time lag. Here, a time period of 5 ms which is close to the maximum readout rate of the CCD 10_41 is defined as the second time interval of the present invention. Accordingly, the AE detection circuit 10_60 detects the amount of illumination light without light emission and causes the flash firing device to perform preliminary light emission 5 ms thereafter to conform to the second time interval. In this way, the AE detection circuit 10_60 detects the total amount of light representing the sum of the amount of preliminarily emitted light and the amount of illumination light.

The process goes to the next step S610 to calculate the appropriate amount of light of main light emission. Then, in step S611, the flash firing device 10_20 performs main light emission at the time of image taking by using the amount of light calculated in step S610.

On the contrary, when the judgment is made in that the shutter release button is not pressed down at once in step S603, the process goes to a No side and a judgment is made in step S604 as to whether or not the sports mode is selected. Here, when the judgment is made that the sports mode is selected, the process goes to a Yes side and a judgment is made in step S613 as to whether or not the shutter release button is fully pressed down. When the full-press action is detected, the process goes to step S612 and the dimming process is executed at the high-speed cycle as similar to the case where the shutter release button is pressed down at once. Then, the amount of light emission is calculated in step S610 and main light emission is performed in step S611. Thereafter, the process in this flow is terminated.

The contents of the high-speed processing are described below, which will be applied to the case when the shutter release button is pressed down at once or when the sports mode is selected for taking an image of a moving object.

A flicker detection process is initiated in step S605 when the process goes to a No side because the shutter release button is not fully pressed down in step S603 and the process further goes to a No side in step S604 as the sports mode is not selected. The process goes to the next step S606 to judge presence of flickers. When the judgment is made that there are no flickers, the process goes to a No side and the digital camera stands by for the full-press action in step S614. When the full-press action is detected in step S614, the process goes to step S612 to execute the dimming process at a high speed. Then, the amount of light emission is calculated in the next step S610. Thereafter, main light emission is performed in the next step S611, and the process in this flow is terminated.

When the judgment is made in step S606 that there are flickers, the process goes to a Yes side and the frequency of the flickers is determined in step S607. When the judgment is made in step S607 that the flickers have the frequency of 50 Hz, the process goes to step S608B, and the digital camera stands by for the full-press action in step S608B. When the full-press action is detected, the process goes to step S609B where the dimming process is performed at the cycle of 10 ms so as to avoid the influence of the intensity variation. The amount of light emission is calculated in the next step S610. In the next step S611, the flash light is emitted at the calculated amount of light emission to perform the image-taking process. Thereafter, the process in this flow is terminated.

Meanwhile, when the judgment is made in step S607 that the flickers have the frequency of 60 Hz, the process goes to step S608A, and the digital camera stands by for the full-press action in step S608A. When the full-press action is detected, the process goes to step S609A where the dimming process is performed at the cycle of 8.33 ms so as to avoid the influence of the intensity variation. The amount of light emission is calculated in the next step S610. In the next step S611, the flash light is emitted at the calculated amount of light emission to perform the image-taking process. Thereafter, the process in this flow is terminated.

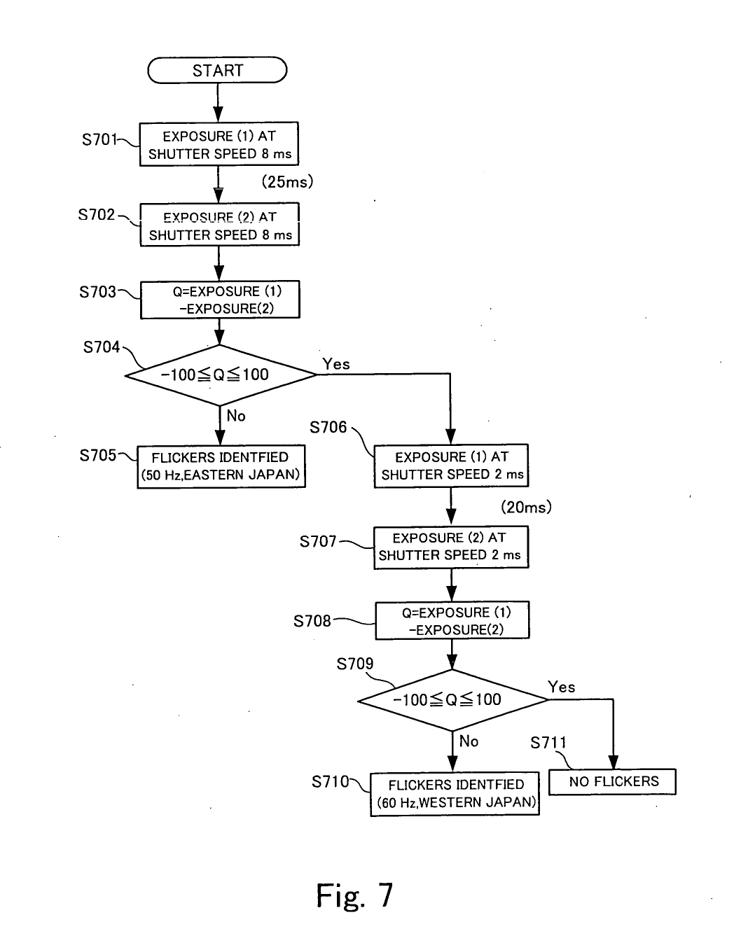

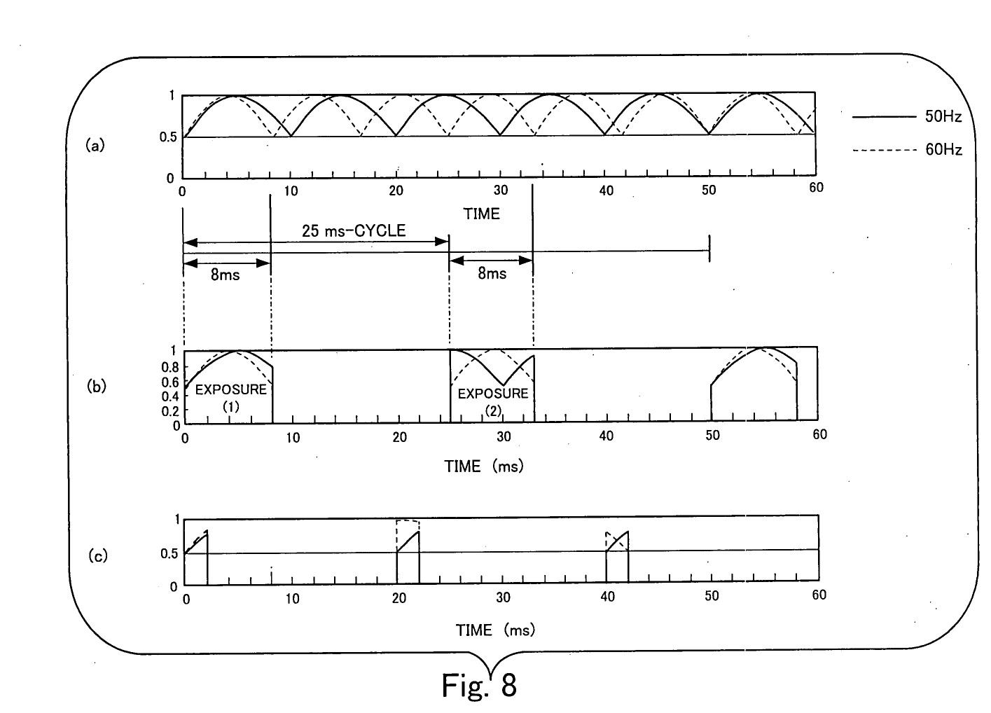

Here, details of the processes will be described in terms of the three steps (as marked by A in the drawing), namely, step S605 of detecting flickers, step S606 of judging presence of the flickers, and step S607 of determining the frequency of the flickers with reference to FIG. 7 and FIG. 8.

FIG. 7 is a flowchart showing procedures of an example of a process for judging whether the intensity variation of the flicker light source is attributed to the commercial power source at the frequency of 50 Hz or to the commercial power source at the frequency of 60 Hz.

In step S701, exposure is performed at a shutter speed of 8 ms without emission of flash light. After a lapse of 25 ms, second exposure is performed in the next step S702 at the same shutter speed while performing preliminary light emission.

In step S703, the amount of light obtained by the second exposure is subtracted from the amount of light obtained by the first exposure. The process goes to the next step S704 where a judgment is made as to whether or not a result of subtraction Q is in a range from −100 to +100 inclusive. The process goes to step S706 if the result is yes. If the result exceeds +100 in step S704, the judgment is made that there are flickers having the frequency of 50 Hz. Then, the process goes to step S705 where the judgment is made that the flickers are attributed to the commercial power source frequency of 50 Hz.

Meanwhile, when the process goes to the Yes side in step S704, exposure is performed in step S706 at a shutter speed of 2 ms without emission of flash light. After a lapse of 20 ms, exposure is performed again in the next step S707 at the shutter speed of 2 ms while causing the flash firing section to perform preliminary light emission this time. In step S708, the amount of light obtained by the second exposure is subtracted from the amount of light obtained by the first exposure. The process goes to the next step S709 where a judgment is made as to whether or not a result of subtraction Q is in a range from −100 to +100 inclusive. When the result is yes, the judgment is made that there are no flickers. Then the process goes to the next step S711 and the process in this flow is terminated. If the result exceeds +100, the judgment is made that there are flickers having the frequency of 60 Hz. Then, the process goes to step S710 and the process in this flow is terminated.

In this way, it is possible to identify whether the contents of flickers are attributed to the commercial power source frequency of 50 Hz or to the commercial power source frequency of 60 Hz. In addition, presence of the flickers is also identified in this process.

Here, the difference in the amounts of exposure is directly used for judgment in step S709. Alternatively, it is possible to perform judgment after calculating logarithms of the amounts of exposure to obtain an EV value. For example, thresholds of the amount of exposure ±100 are equivalent to the EV values of ±0.3 EV. Moreover, although subtraction is performed after performing the exposure twice, it is also possible to perform the exposure three times or more.

FIG. 8 is a diagram for explaining the process shown in the flowchart of FIG. 7.

Part (a) of FIG. 8 is a diagram showing a time lag between the time when the intensity variation at the cycle of 1/50 s (50 Hz) is emerging and the time when the intensity variation at the cycle of 1/60 (60 Hz) is emerging. In the drawing, a solid line shows the waveform at the frequency of 50 Hz and a dashed line shows the waveform at the frequency of 60 Hz.

Part (b) of FIG. 8 is a diagram for explaining the processes from step S701 to step S705 in the flowchart of FIG. 7. Part (b) of FIG. 8 is the diagram for showing a temporal relation between the first exposure performed at the shutter speed of 8 ms and the time when the second exposure performed after the lapse of 25 ms.

Part (b) of FIG. 8 shows the basis of judgment as to whether or not the flicker light source is operated by the power supply at the commercial power source frequency of 50 Hz.

As shown in FIG. 4, in the case of the frequency of 50 Hz, the zero point appears at every 10 ms as a result of half-wave rectification. Meanwhile, in the case of the frequency of 60 Hz, the zero point appears at every 8.33 ms as a result of half-wave rectification. In the first embodiment, the process is carried out based on the cycle of 50 ms so as to standardize the procedures irrespective of whether the frequency is equal to 50 Hz or 60 Hz.

However, the procedures based on the 50 ms-cycle are time-consuming. Accordingly, the second embodiment focuses attention on the aspect that a peak of the intensity variation at the frequency of 60 Hz appears in the vicinity of the zero point of the intensity variation at the frequency of 50 Hz except for the starting point, and on the aspect that a peak of the intensity variation at the frequency of 50 Hz appears in the vicinity of the zero point of the intensity variation at the frequency of 60 Hz on the contrary. Based on these aspects, the second embodiment is devised to identify the frequency of 50 Hz or 60 Hz by performing exposure more than once in the vicinities of those zero points.

As shown in part (b) of FIG. 8, the aspects of the intensity variation are almost similar between the frequencies of 50 Hz and 60 Hz in the case of the first exposure. In other words, there is relatively a small difference in the amounts of light between the first exposure and the second exposure 25 ms after the first exposure. On the contrary, in the case of the second exposure, there is a large difference in the amounts of light observed between the first exposure and the second exposure. As it is apparent in part (b) of FIG. 8, the intensity variation attributed to the frequency of 50 Hz and the intensity variation attributed to the frequency of 60 Hz exhibit a similar phase relation at the time of 0 ms. On the contrary, these two aspects of the intensity variation are deviated approximately by 90 degrees at the time of the second exposure. For this reason, in the case of performing the exposure twice as shown in part (b) of FIG. 8, the difference in the amounts of light between the second exposure and the first exposure becomes less than 100 when the frequency is equal to 60 Hz. On the contrary, the difference in the amounts of light between the second exposure and the first exposure becomes considerably large (100>Q or Q<−100 according to FIG. 7, Q is the difference in the amounts of light) when the frequency is equal to 50 Hz. In other words, when the exposure of 8 ms is performed more than once in every 25 ms, it is possible to identify the presence of the flicker light source operated at the commercial power source frequency of 50 Hz if there is a large difference in the amounts of light between the odd-numbered exposure and the even-numbered exposure, for example.

Meanwhile, in order to identify the presence of the flicker light source operated at the commercial power source frequency of 60 Hz, the exposure is supposed to be performed in the vicinity of 20 ms where the intensity variation is located close to the zero point in the case of the frequency at 50 Hz while the intensity variation shows the peak in the case of the frequency at 60 Hz.

As shown in part (c) of FIG. 8, when the exposure is performed more than once at the shutter speed of 2 ms in every 20 ms, it is possible to identify the presence of the flicker light source operated at the commercial power source frequency of 60 Hz.

The foregoing explanation is merely an example. In reality, it takes some time when the flow in FIG. 7 is executed after the full-press action of the shutter release button. However, for example, in a situation where a user does not move at a high speed in the course of displaying the through image in order to take an image indoors, it is not necessary to perform the processes in the flow in FIG. 7 after the full-press action. In other words, in such a situation, whether the flicker light source is operated at the commercial power supply frequency of either 50 Hz or 60 Hs may be identified immediately before image taking. In this way, it is possible to reduce the cycle of the dimming process down to 8.33 ms or to 10 ms, for example.

As described above, it is possible to realize an image-taking apparatus which optimizes exposure in the case of image taking by use of flash light under a flicker light source.

What is claimed is:

1. An image-taking apparatus which performs image taking by use of flash firing depending on an image-taking operation, the image-taking apparatus comprising:
a flash firing section which performs preliminary light emission at a given amount of light prior to image taking and performs main light emission at a controlled amount of light at the time of image taking;
a light amount calculating section which measures an amount of light received from an object field at the time of emitting no flash light and an amount of light received from the object field at the time of the preliminary light emission respectively at a time interval satisfying an identical phase to an intensity variation of illumination light when the object field is exposed to illumination by a flicker light source, and calculates an amount of light to be emitted at the time of the main light emission of the flash light based on the amounts of received light; and
a light amount controlling section which causes the flash firing section to emit light at the amount of light calculated by the light amount calculating section.

2. The image-taking apparatus according to claim 1, further comprising:
a flicker detecting section which detects whether the object field is exposed to illumination by the flicker light source,
wherein the light amount calculating section measures the amount of light received from the object field at the time of emitting no flash light and the amount of light received from the object field at the time of the preliminary light emission respectively at a first time interval satisfying the identical phase to the intensity variation of illumination light when the flicker detecting section detects that the object field is exposed to illumination by a flicker light source, and calculates the amount of light to be emitted at the time of the main light emission of the flash light based on the amounts of received light, and
the light amount calculating section measures the amount of light received from the object field at the time of emitting no flash light and the amount of light received from the object field at the time of the preliminary light emission respectively at a second time interval shorter than the first time interval when the flicker detecting section detects that the object field is not exposed to illumination by the flicker light source, and calculates the amount of light to be emitted at the time of the main light emission of the flash light based on the amounts of received light.

3. The image-taking apparatus according to claim 2, further comprising:
a release button of a two-stage type which allows a full-press action and a half-press action,
wherein the light amount calculating section is operated by the full-press action,
when the release button is fully pressed down at once, the light amount calculating section measures the amount of light received from the object field at the time of emitting no flash light and the amount of light received from the object field at the time of the preliminary light emission respectively at the second time interval, and calculates the amount of light to be emitted at the time of the main light emission of the flash light based on the amounts of received light.

4. The image-taking apparatus according to claim 2, further comprising:
a mode selecting section which selects a desired image-taking mode out of a plurality of image-taking modes defining mutually different image-taking conditions,
wherein the light amount calculating section measures the amount of light received from the object field at the time of emitting no flash light and the amount of light received from the object field at the time of the preliminary light emission respectively at the second time interval depending on the image-taking mode selected by the mode selecting section, and calculates the amount of light to be emitted at the time of the main light emission of the flash light based on the amounts of received light.

5. The image-taking apparatus according to claim 2,
wherein the flicker detecting section detects whether the object field is exposed to illumination by a flicker light source, and detects a cycle of flickers when the object field is exposed to the flicker light source, and
the light amount calculating section measures the amount of light received from the object field at the time of emitting no flash light and the amount of light received from the object field at the time of the preliminary light emission respectively at the first time interval synchronized with the cycle detected by the flicker detecting section, and calculates the amount of light to be emitted at the time of the main light emission of the flash light based on the amounts of received light.
